(19) United States
(12) Patent Application Publication
(10) Pub. No.: US 2017/0300834 A1
(43) Pub. Date: Oct. 19, 2017

(54) MOVING OBJECTS WITH AUTOMATIC EVALUATION FUNCTION

(71) Applicant: Hitoshi ISHIDA, Tokyo (JP)

(72) Inventor: Hitoshi ISHIDA, Tokyo (JP)

(21) Appl. No.: 15/430,537

(22) Filed: Feb. 12, 2017

(30) Foreign Application Priority Data
Feb. 17, 2016 (JP) 2016-028441

(51) Int. Cl. G06Q 30/02

(52) U.S. Cl. CPC G06Q 3/06; G06Q 30/0284; G06F 2219/10

(57) ABSTRACT

If a moving object in use at a certain time calculates and displays a reselling price thereof in real time, it is possible to use the reselling price effectively for determining the replacement time of the moving object, and recognize the asset value of the moving object in real time, to effectively use the reselling price when using a financial aid and the like.

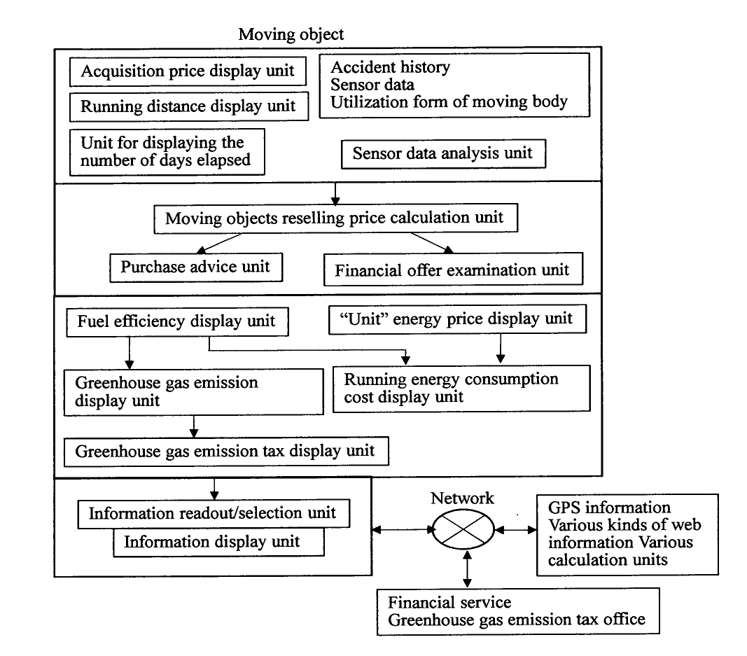

The moving object calculates and displays a reselling price when using the moving object (in real time), using the acquisition price of the moving object, and at least one of the running distance and the number of days elapsed from the time of acquisition of the moving object.

### CROSS-REFERENCE TO RELATED APPLICATIONS

This application is a continuation of U.S. application Ser. No. 15/430,537, filed Feb. 12, 2017, which claims priority from a Japanese patent application No. 2016-028441, filed on Feb. 17, 2016, the entire content of which is incorporated herein by reference.

### BACKGROUND OF THE INVENTION

The present invention relates to a moving object with automatic evaluation function, which is configured by adding, to a moving object such as car, motor cycle, airplane and bicycle, a function of displaying a reselling price of the moving object in real time, advising replacement to another moving object, and displaying greenhouse gas emissions.

### DESCRIPTION OF THE RELATED ART

There has not been a moving object having a function of displaying a reselling price of the moving object when the moving object is being used. In addition, there has not been a moving object having a function of advising replacement to another moving object based on the reselling price thereof, or displaying the greenhouse gas emission when running.

### SUMMARY OF THE INVENTION

Many of owners of moving object will replace someday the moving object currently in use.

When replacing a moving object, the reselling price of the moving object currently in use serves as an important decision element for the owner along with the price of a moving object to be newly purchased.

Accordingly, if a moving object in use at that time has a function of calculating and displaying a reselling price thereof in real time, said function would be convenient and effective in order for the owner of the moving object to determine a replacement time and the like.

In addition, the owner can accurately and easily manage his/her own asset if the owner of a moving object can always know the asset value of the moving object, i.e., the reselling price thereof.

Furthermore, a large advantage can be produced for the owner of a moving object and a financial service provider if the financial service provider can know in real time the asset value of the moving object presently in use, wherein when the financial service provider determines or examines a financial service provision, said determination or examination can be efficiently and rapidly carried out.

A moving object with automatic evaluation function according to the first invention of the present application is provided with a moving object acquisition price display unit that inputs or display the acquisition price of the moving object, and at lease either one of a running distance display unit that displays a running distance of the moving object and an elapsed days display unit that inputs or displays the number of days elapsed from the time of acquisition of the moving object, wherein said moving object is further provided with a moving object reselling price calculation unit that calculates a reselling price of the moving object based on at least one of the running distance of the moving object and the number of days elapsed from the time of acquisition of the moving object, and a reselling price display unit that displays the numerical value calculated by the moving object reselling price calculation unit.

The running distance display unit may associate information on a distance that the moving object has run, with information on a time when the moving object has run said distance, and store the associated information in a storage unit.

The moving object with automatic evaluation function according to the present invention may be further provided with an accident history input/display unit that inputs or displays an accident history of the moving object, wherein the moving object reselling price calculation unit may further take into account the accident history of the moving object, which the accident history input/display unit inputs or displays, to calculate a reselling price of the moving object.

The moving object with automatic evaluation function according to the present invention may be further provided with a sensor data analysis unit that analyzes data of various sensors mounted to the moving object for detecting a driving situation, wherein the moving object reselling price calculation unit may calculate a reselling price of the moving object based on the analysis result obtained by the sensor data analysis unit.

The moving object with automatic evaluation function according to the present invention may be further provided with a purchase advice unit that provides an advice when newly purchasing another moving object, based on a reselling price of the moving object, which the moving object reselling price calculation unit calculates.

The moving object with automatic evaluation function according to the present invention may be further provided with a financial offer examination unit that determines or examines a financial offer to the owner of the moving object, based on a reselling price of the moving object, which the moving object reselling price calculation unit calculates.

The moving object with automatic evaluation function according to the present invention may be further provided with a fuel efficiency display unit that displays a real-time fuel efficiency of the moving object, a “unit” energy price display unit that inputs or displays a “unit” energy price of the drive energy of the moving object, and a running energy consumption cost display unit that calculates a running energy consumption cost when the moving object has run the running distance, based on the fuel efficiency, the running distance displayed by the running distance display unit, and the “unit” energy price.

The moving object with automatic evaluation function according to the present invention may be further provided with a greenhouse gas emission calculation unit that calculates a greenhouse gas emission based on the fuel efficiency, the running distance and a greenhouse gas emission coefficient, and a greenhouse gas emission display unit that displays a greenhouse gas emission, which is calculated by the greenhouse gas emission calculation unit.

The moving object with automatic evaluation function according to the present invention may be further provided with a greenhouse gas emission calculation unit that calculates a tax associated with a greenhouse gas emission based on a greenhouse gas emission, which is calculated by the greenhouse gas emission calculating unit, and a greenhouse gas emission display unit that displays a tax associated with a greenhouse gas emission based on a greenhouse gas emission, which is calculated by the greenhouse gas emission calculation unit.

The present invention enables an owner (purchaser or introducer) of a moving object to know a reselling price, i.e., a purchasing price seen from a used car sales company, of the moving object in real time when driving the moving object.

Accordingly, it is possible to refer to and use the reselling price as an important element when purchasing a new moving object, for daily evaluation and management of self-assets, and when using a financial aid.

In addition, in situations in which warming rises to the surface, the present invention provides an effect such that an individual owner of a moving object is aware at all time of the greenhouse gas emission, and is very useful when administration effectively collects greenhouse gas tax according to the greenhouse gas emission.

### BRIEF DESCRIPTION OF THE DRAWINGS

The drawing is an example of a functional block diagram indicating the overall configuration of a system of moving object with automatic evaluation function according to the present invention.

### DESCRIPTION OF THE EMBODIMENTS

Embodiment 1 of the present invention is provided with a moving object acquisition price display unit that inputs or displays an acquisition price of a moving object, and at least one of a running distance display unit that displays the running distance of the moving object and an elapsed days display unit that inputs or displays the number of days elapsed from the time of acquisition of the moving object, wherein

embodiment 1 is further provided with a moving object reselling price calculation unit that calculates a reselling price of the moving object based on at least one of the running distance and the number of days elapsed from the time of acquisition of the moving object, and a reselling price display unit that displays the numerical value calculated by the moving object reselling price calculation unit.

Note that the moving object is applicable to all moving bodies that run on the ground by drive energy, such as passenger car, truck, bus, motor cycle and electric bicycle, for example. In addition, the present invention is applicable also to machines such as airplane, which fly in the sky by drive energy, and helicopter. Furthermore, the present invention is applicable also to machines such as ship, which run on the sea. Moreover, the present invention is applicable also to equipment and machines such as home electric appliance and factory machine, which operate by drive energy. In that case, the “running distance of a moving object” is the operating time of home electric appliance, factory machine and the like.

A moving object purchased price, taxes (registration fee, weight tax, carbon tax and the like), insurance fees (compulsory automotive liability insurance fee, voluntary automotive insurance fee), financial interest and the like could be listed, for example, as the acquisition price of a moving object, which is displayed by the moving object acquisition price display unit. In addition, repair cost, automotive inspection cost, other inspection cost, parking fee, road use fee (highway fee and the like), drive energy consumption cost (note that running energy consumption cost is separately categorized and handled in the present invention that is discussed later in an embodiment and the like), scrap cost and the like could be listed as the maintenance fee of the moving object.

The manufacturing date, manufacturer's name, model name, trim (detailed model number), manufacturer suggested retail price or purchase price and the like of the moving object, which are stored or inputted, may be displayed on the acquisition price display unit.

These pieces of information on the moving object may be either the pieces of information that are stored in a storage unit of the moving object, or the pieces of information that are inputted and stored by a purchaser and the like of the moving object.

The acquisition price of a moving object may be stored in a storage unit of the moving object already by the time of purchase, or may be inputted by the purchaser thereof after the purchase, and thereafter the inputted data may be stored in the storage unit. In addition, data on a network may be stored in a storage unit of said moving object via the network by connecting a transmitting and receiving unit of the moving object to the network.

Storage media configuring the storage unit may be a storage device in any format such as magnetic disk format, optical disk format, flash memory format and magneto-optical disk format, as far as said storage device can store data.

A method for displaying a running distance of a moving object, which is displayed on the running distance display unit, may be the same as a running distance display method of a moving object, which is currently used in moving bodies and the like. In other words, for example, a method in which rotary pulses of the wheel and axle of a moving object are electrically sensed and converted would work. However, the running distance display method is not limited to the aforementioned method,

but may be any display method or measurement method such as a method, for example, in which GPS (Global Positioning System) mounted to a moving object is utilized to acquire a moving distance via a network, and other methods.

In addition, the running distance display unit of a moving object may be capable of calculating and displaying a running distance during a certain period of time. In other words, the running distance display unit may be configured in such a manner that a user of a moving object can display a moving distance during a certain week or a running distance during a certain day, for example.

A method enabling calculation of running distance during a certain period of time may be configured in such a manner that data on a distance that a moving object has run and data on a time when the moving object has run said running distance are associated to each other (as linked data) and managed, to be stored in a storage unit.

The time data may be managed and stored by being associated to running distance data using year, month, day, hour, minute and second, for example.

In addition, in a case where a certain period of time is specified and a running distance during the specified period of time is calculated and displayed, a period to be specified may be inputted from an input unit, and a running distance linked to time data may be read out from a storage unit by an information readout/selection unit, thereby executing calculation. Or, a running distance may be calculated by voice input to execute calculation, in a similar manner.

A running energy consumption cost and greenhouse gas emission, which are mentioned later, during a certain period of time can be thereby calculated and displayed.

A method for correlating running distances to time data is configured in such a manner that times when running are stored in a storage unit along with running distances, with respect to a predetermined running distance displaying “unit” of a moving object, in the interval of the running distance displaying “unit” (sequentially for each running distance “unit”), using the first running as a trigger from a state where, for example, the running distance is zero.

In addition, in a moving object that has already run a certain distance, said method may also be configured in such a manner that times while running after a previous running distance is reset can be newly stored in a storage unit by being associated to running distances, from the time of reset.

Furthermore, said method may also be configured in such a manner that times while running are associated to running distances, whereby it is possible to sequentially calculate and display running distances in a certain period of time that is predetermined by a user, such as seven days after Jan. 1, 2016, the next seven days, and the next seven days thereafter, which the user wants.

The number of days elapsed from the time of acquisition of a moving object, which is displayed on an elapsed days display unit, is the number of days elapsed from the time when an introducer or purchaser of the moving object newly introduced or purchased the moving object. In addition, the unit for displaying the number of days elapsed may display days of ownership or years of ownership. Or, the unit for displaying the number of days elapsed may display days or years passed from the production of the moving object to the day of usage thereof.

The unit for displaying the number of days elapsed of a moving object may be configured in such a manner that an introducer or purchaser of the moving object starts counting the days elapsed at the day when the introducer or purchaser newly introduced or purchased the moving object. The unit for displaying the number of days elapsed of a moving object may be equipped with a switch for the introducer or purchaser of the moving object to start counting the number of days elapsed thereof. In addition, the start of counting may be instructed by voice input.

A power source and a clock, for example, which are mounted to a moving object, can be used for displaying the number of days elapsed from a certain fixed date. Note that the method for displaying the number of days elapsed may be a method other than the methods described here.

The reselling price of a moving object, which is calculated by the moving object reselling price calculation unit, is displayed in real time at daily usage of the moving object. It is possible for the owner of the moving object to know the reselling price in real time, thereby use the reselling price as an important base for decision on current asset management and replacement time, and an important base for decision on use of a financial service based on owned assets.

Furthermore, daily reselling prices are displayed and stored, whereby it is possible to estimate reselling price decrease in next few years, and thus serve as an important document for decision on replacement time, asset management, use of financial service and the like. In addition, it is possible to clarify decision on replacement time and consider various options by analyzing displayed values of a real-time fuel efficiency to be discussed later, and running energy cost and greenhouse gas emission based on the real-time fuel efficiency, in combination with the reselling price.

It is possible to estimate and calculate a reselling price of a moving object in a moving object reselling price calculation unit by a calculation method, for example, based on basic elements and numerical values such as the name, model, purchased price, number of days elapsed, running distance of the moving object, and by using and analyzing, in addition to the basic elements and numerical values, the history of accident and failure, and numerical elements (coefficients) generated by various sensors mounted to the moving object, such as acceleration sensor, 3D sensor, gyroscope sensor, optical sensor, other physical sensor and chemical sensor, in combination with the basic elements.

Note that any element may be used as the numerical value and element for calculating a reselling price of a moving object, other than the abovementioned elements and vehicle-mounted sensors, as far as the reselling price of the moving object can be thereby calculated and displayed in the moving object. For example, a reselling price may be estimated and calculated by acquiring the usage situation and moving situation of a moving object via a network, and combining same with the aforementioned basic elements and the like.

Furthermore, elements (coefficients) for calculating a purchasing price (reselling price) of a moving object can be inputted, as the element for calculating a reselling price of the moving object, from an input unit, considering the usage method (utilization form) of the moving object, i.e., commuting, leisure, transportation, commercial, shopping, commuting to school, and the like, the number of days per week to use, and the average running distance per day, which are the frequencies of use of the moving object.

Note that the abovementioned input unit may use a method in which an input unit using a finger touch is provided to a display panel or a display for inputting, a method in which a voice recognition input unit is used for inputting, a method in which a network is used for acquiring data on the moving object, or the like. Note also that the input method pertaining to the input unit is not limited to the abovementioned methods, but may be any method as far as elements for calculating a reselling price can be inputted in said method.

The moving object reselling price calculation unit may be configured in such a manner that one or more coefficients for calculating an expected moving object reselling price are stored, as an example of method for calculating a reselling price of a moving object. In other words, when obtaining a real-time reselling price of said moving object using the moving object acquisition price of a candidate moving object for purchasing, for example, as basic price data, a running distance coefficient based on running distance and the number of days elapsed coefficient based on the number of days elapsed may be predetermined in advance. In other words, a real-time expected reselling price of said moving object is configured in such a manner as to be calculated by multiplying or dividing, for example, the acquisition price of a moving object with the predetermined running distance coefficient and the number of days elapsed coefficient.

The abovementioned running distance coefficient is configured so as to be set in such a manner that the longer the running distance of said moving object is, the more the reselling price thereof decreases.

In addition, the moving object reselling price calculation unit may also be configured in such a manner that a popularity coefficient is set so as to determine the reselling price of a highly popular moving object higher than that of an unpopular moving object.

Furthermore, when calculating a reselling price of a moving object in the moving object reselling price display unit, it is possible to take input information on the method for utilization (commuting, leisure, transportation, commercial and the like) into account to calculate the moving object reselling price, said input information being inputted by the owner of the moving object. In other words, as it is assumed that a moving object is damaged quickly in a case where the moving object is used for transportation and/or commercial, for example, it is possible to configure in such a manner that the reselling price of such a moving object is set to be lower than that of another moving object in a case where said another moving object is used for commuting and/or leisure. Moreover, it may be possible to configure in such a manner that the method for utilization (commuting, leisure, transportation, commercial and the like) of a moving object is set as a utilization method coefficient.

In addition, the moving object reselling price display unit may display a moving object reselling price by linking, via a network, to a reselling price calculation unit served by a third party, and inputting a car name and a model thereto.

An example of a method for calculating a reselling price of a moving object based on the running distance of the moving object, which is displayed on a running distance display unit, is shown below.

The reselling price of a moving object typically decreases if the running distance thereof is large.

Here, a coefficient K of a running distance for calculating a reselling price is set, for example. The coefficient K may be set to a distance such as 100,000 km or 200,000 km as the running distance corresponding to a state where the price value of a moving object is lost, i.e., as the running distance at which the reselling price of the moving object is zero yen.

A coefficient K1 pertaining to a running distance may be set to 100,000 km as the running distance at which the reselling price of a moving object is zero yen, for example, and the reselling price display unit may calculate the reselling price of the moving object of the day at which the running distance of the moving object reached 50,000 km, to be 50 percent the purchased price thereof. Or, the reselling price of the moving object may be calculated by analyzing other elements and separately adding a that is plus or minus to 50 percent the purchased price as a reference value.

In a similar way of thinking, a coefficient K2 pertaining to an elapsed days display unit for calculating a reselling price may be set to 10 year or 20 year, for example, as a year in a state where the price value of a moving object is lost, i.e., a year at which the price value thereof is estimated to zero yen.

When a coefficient K2 pertaining to the number of days elapsed is set to 10 year as the year at which the reselling price of the moving object is zero yen, for example, the reselling price display unit may calculate the reselling price of the moving object of the day at which 5 years have passed from the purchase date, introduction date or production date of the moving object, to be 50 percent the purchased price thereof. Or, the reselling price of the moving object may be calculated by analyzing other elements and separately adding a that is plus or minus to 50 percent the purchased price as a reference value.

The reselling price display unit may calculate and display an average value (half the sum) of reselling prices calculated based on the running distance display unit and the unit for displaying the number of days elapsed.

In addition, the reselling price display unit may display, as a reselling price, either a smaller value or larger value of reselling prices calculated based on the running distance display unit and the unit for displaying the number of days elapsed.

The reselling price display unit (illustrated as information display unit in the Drawing) for displaying a reselling price is configured with a display having a liquid crystal structure, for example.

In addition, the display unit for displaying a reselling price may not necessarily be a display device, but may be a display unit using voice from a speaker device.

An accident history displayed by an accident history display unit may be inputted and stored in a storage unit by the owner of a moving object after having experienced an accident, or a 3D gyro sensor, for example, mounted to the moving object may analyze an impact to the moving object and store the impact as an accident history in a storage unit.

In that case, an accident history G may be set as a “unit” representing the magnitude of impact of the accident or the magnitude and the like of a damage to the moving object, whereby determining an accident as G1, G2, G3, G4 or G5, for example, in descending order of the damage, and storing, in a storage unit, the accident history along with the time of encountering the accident.

The reselling price of a moving object having an accident history G3, for example, may be thereby calculated by multiplying a reselling price evaluated by the running distance or the number of days elapsed thereof with 3/6 (3 of 6) or 3/7 (3 of 7), for example. Note that a method for calculating a reselling price based on an accident history is not limited to the method described here.

In addition, a reselling price may be calculated in such a manner that various physical sensors, chemical sensors and the like, which are mounted to a moving object, detect, acquire or store the moving situation, usage situation, driving situation and the like of the moving object at all time, and

an accident history to be displayed by an accident history display unit may be analyzed by a sensor information analysis unit mounted to the moving object or connected via a network, whereby said reselling price is calculated based on the analysis result.

Here, the reselling price may be calculated in such a manner that rapid acceleration, rapid deceleration, various steering operations, average speed and the like are detected, acquired or stored, and data thereof is analyzed by a sensor data analysis unit configured with CPU and AI (artificial intelligence), whereby said reselling price is calculated based on the analysis result.

First of all, a function of the present invention is explained here, wherein a reselling price of a moving object, which is calculated by the moving object reselling price calculation unit, is further utilized.

A purchase advice unit provides an advice and the like for replacing to a next new moving object to the owner of a moving object, for example, based on a reselling price calculated by the moving object reselling price calculation unit.

Basic reference elements when providing a purchase advice include the followings:
1. an average number of years for owning a moving object by the owner or purchaser of the moving object (the number of years until replacement);
2. a situation where a reselling price becomes less than or equal to a certain percentage of the purchased price;
3. a situation where the fuel efficiency of the moving object reduced, whereby an increase of a running energy consumption cost and the greenhouse gas emission becomes more than or equal to a certain percentage; and
4. a situation where some benefits more than or equal to a certain percentage can be obtained by replacing to the same moving object or a newly released moving object.

Note that when providing a purchase advice, reference elements are not limited to the examples described here, but may be any one that can be provided from the purchase advice unit.

In addition, the abovementioned certain percentage may be determined by the owner of the moving object, may be determined by an expert on moving bodies, or may be determined by judging average benefits and disadvantages pertaining to replacement of the moving object. Furthermore, the method for determining the abovementioned certain percentage is not limited to the method described here, but may be other method that can be provided from the purchase advice unit.

There may be a case where a purchase advice provided from the purchase advice unit is executed only by information obtained from the moving object, or the purchase advice may be provision of information which is considered to be advantageous with respect to replacement and the like, by acquiring, via a network, information present on the network or in other information sources, or by comparing such information with the current situation.

The financial offer examination unit displays a decision element or examination element for providing a financial service, based on a reselling price calculated by a moving object reselling price calculation unit. The current reselling price is also a display of an asset value, enables the decision of financial service provision, and is useful for broadening options of financial behavior, as previously mentioned.

The financial offer examination unit is connected to financial service providers and the like via a network, and thus is capable of exchanging information with respect to giving, receiving and the like of financial service provision.

The fuel efficiency display unit displays current real-time fuel efficiency. A method therefor may be one achieved in existing moving bodies (vehicle and the like, for example), and may not necessarily be one by an original technology, in particular.

The “unit” energy price display unit inputs or stores, and displays a real-time energy price per unit. The “unit” energy price display unit may be connected, via a network, to information indicating daily energy price per “unit”, to acquire said information.

In addition, the “unit” energy price display unit displays a “unit” energy price of energy for operating a moving object, and corresponds to gasoline, gas, electricity, hydrogen, diesel, heavy oil, ethanol and the like, for example, which are currently used energy sources, and any energy source for moving bodies, which will be developed in the future.

The greenhouse gas emission display unit calculates a current real-time greenhouse gas emission of a moving object, using a fuel efficiency displayed by the fuel efficiency display unit, a running distance displayed by the running distance display unit, and a greenhouse gas emission coefficient determined for each drive energy, and displays the calculated real-time greenhouse gas emission.

The greenhouse gas emission display unit calculates greenhouse gas emission based on a greenhouse gas emission displayed by the greenhouse gas emission display unit, and displays the calculated greenhouse gas emission.

The greenhouse gas emission display unit is connected, via a network, to a tax collection agency that collects greenhouse gas emission, to mutually exchange information on greenhouse gas emission, and the like, and separately connected to a payment system, thereby being capable of paying the greenhouse gas emission.

The running energy consumption cost display unit calculates a running energy consumption cost for a running distance, using a running distance displayed by the running distance display unit, a fuel efficiency displayed by the fuel efficiency display unit, and a “unit” energy price displayed by the “unit” energy price display unit, and displays the calculated running energy consumption cost.

For example, when the current running distance is 50,000 km, the fuel efficiency is 20 km/L and the price of gasoline at that time is 130 yen/L, a consumption cost of running energy is

325,000 yen (=50,000/20×130)

in a case where said running distance has been run.

As previously mentioned, a running distance to be displayed by the running distance display unit can be calculated by designating a running distance for a certain period of time such as seven days up to yesterday, and one year up to yesterday, for example.

Accordingly, the running energy consumption cost display unit for displaying base on a running distance can calculate and display a running energy consumption cost for a certain period of time. It is thereby possible to display the present running energy consumption cost compared with the running energy consumption cost one year ago, for example. In addition, it is possible to estimate disadvantage derived from change in future running energy consumption cost, i.e., the rise of energy consumption cost based on factors such as decrease of fuel efficiency, by comparing running energy consumption costs after one year and two years from the purchase of a moving object, to each other. Prediction information on the disadvantage serves as an important base for decision when determining a replacement time.

The same applies to the display of the aforementioned greenhouse gas emission, wherein it is possible to predict greenhouse gas emissions in the future.

It is possible to determine a replacement time using these pieces of prediction data.

The information display unit is configured with a display, a speaker and the like, for example, so as to display information and images read out by various display units and information readout/selection units, characters inputted by the owner of a moving object, and images and voices of web information, utilization guidance and the like. The information display unit may have a unit for temporally storing information displayed on said display unit in a flash memory or other medium. In addition, said information display unit is configured so as to display various kinds of web information and information obtained by connecting to a server device, via a network, using a transmitting and receiving unit in a moving object.

The information readout/selection unit is configured with a display (that may use an information display unit), a text input unit, a microphone unit (voice input unit) and a light sensor unit such as camera.

The information readout/selection unit provides an instruction for performing various kinds of data input and various kinds of calculation by the owner or user of a moving object, using text input, voice input, motion input and the like.

The motion input detects, using a camera or optical sensor, and recognizes a motion of the user of a moving object, to execute instruction that the user of the moving object wants. The motion input is configured so as to be capable of detecting and recognizing blinks of eyes of the user of a moving object, for example, and providing various orders and instructions for the user of the moving object, by a method for propagating information using a difference in blinks of the left and right eyes, a method for propagating information using a difference in the number of blinks of the left and right eyes, or, in addition thereto, a method for propagating information using a combination of the difference in the blinks of the left and right eyes and the difference in the number of the brinks thereof.

Various calculation units are configured with, for example, an arithmetic processing unit and analysis equipment such as a CPU of a computer mounted to a moving object, an external arithmetic unit and AI that are capable of being connected via a network, wherein instructions and programs for the abovementioned calculation can be constructed using, for example, C++, CGI and Java Script (registered trademark).

Note that the abovementioned instruction method or program may not necessarily be a particularly limited method or program. In addition, various calculation units may have a unit which temporally stores, in a flash memory or the like, each piece of information that is read out and selected by the information readout/selection unit and/or information that is inputted by an owner.

What is claimed is:

1. A moving object with automatic evaluation function, which is provided with a moving object acquisition price display unit that inputs or displays the acquisition price of the moving object, and at least one of a running distance display unit that displays a running distance of the moving object and an elapsed days display unit that inputs or displays the number of days elapsed from the time of acquisition of the moving object, wherein
said moving object is further provided with a moving object reselling price calculation unit that calculates a reselling price of the moving object based on at least one of the running distance of the moving object and the number of days elapsed from the time of acquisition of the moving object, and
a reselling price display unit that displays the numerical value calculated by the moving object reselling price calculation unit.

2. A moving object with automatic evaluation function described in claim 1, which is characterized in that the running distance display unit associates data on a distance that the moving object has run, with data on a time when the moving object has run said distance, to store the associated data in a storage unit in a state where said data can be read out.

3. A moving object with automatic evaluation function described in claim 2, which is characterized in being further provided with an accident history input/display unit that inputs or displays an accident history of the moving object, wherein
the moving object reselling price calculation unit further takes into account the accident history of the moving object, which the accident history input/display unit inputs or displays, to calculate a reselling price of the moving object.

4. A moving object with automatic evaluation function described in claim 2, which is further provided with a sensor data analysis unit that analyzes data of various sensors mounted to the moving object for detecting a driving situation, wherein
the moving object reselling price calculation unit calculates a reselling price of the moving object based on the analysis result obtained by the sensor data analysis unit.

5. A moving object with automatic evaluation function described in claim 2, which is further provided with a purchase advice unit that provides an advice when newly purchasing another moving object, based on a reselling price of the moving object, which is calculated by the moving object reselling price calculation unit.

6. A moving object with automatic evaluation function described in claim 2, which is further provided with a financial offer examination unit that determines or examines a financial offer to the owner of the moving object, based on a reselling price of the moving object, which is calculated by the moving object reselling price calculation unit.

7. A moving object with automatic evaluation function described in claim 2, which is further provided with
a fuel efficiency display unit that displays a real-time fuel efficiency of the moving object, a “unit” energy price display unit that inputs or displays a “unit” energy price of the drive energy of the moving object, and
a running energy consumption cost display unit that calculates a running energy consumption cost when the moving object has run the running distance, based on the fuel efficiency, the running distance displayed by the running distance display unit, and the “unit” energy price.

8. A moving object with automatic evaluation function described in claim 2, which is further provided with
a greenhouse gas emission calculation unit that calculates a greenhouse gas emission based on the fuel efficiency, the running distance and a greenhouse gas emission coefficient, and
a greenhouse gas emission display unit that displays a greenhouse gas emission, which is calculated by the greenhouse gas emission calculation unit.

9. A moving object with automatic evaluation function described in claim 2, which is further provided with
a greenhouse gas emission calculation unit that calculates a tax associated with a greenhouse gas emission based on the greenhouse gas emission which is calculated by the greenhouse gas emission calculating unit, and
a greenhouse gas emission display unit that displays a tax associated with a greenhouse gas emission based on the greenhouse gas emission which is calculated by the greenhouse gas emission calculation unit.
